(19) United States
(12) Patent Application Publication
(10) Pub. No.: US 2012/0224181 A1
(43) Pub. Date: Sep. 6, 2012

(54) Wide-Band/High-Resolution Tunable Spectral Filter

(75) Inventor: Hongxia Lu, Ottawa (CA)

(73) Assignee: Ms. Hongxia Lu, Ottawa (CA)

(21) Appl. No.: 13/466,988

(22) Filed: May 8, 2012

(51) Int. Cl. G01B 9/02; G02B 27/42; G02B 13/08; G02B 27/28

(52) U.S. Cl. 356/477; 359/491.01

(57) ABSTRACT

The present invention relates to tunable spectral filters. A wide-band/high-resolution tunable spectral filter uses a single transmissive diffraction element in a double pass configuration. The double pass is provided and separated laterally by a retro-reflective mirror working with a half wave plate, which reduces effectively polarization-dependent loss (PDL). The transmissive diffraction element in low dispersion configuration provides a wide-band operation. An anamorphic system is disposed for increasing filter spectral resolution to a desirable level. The continuous tuning of a selected spectral portion from input port over a wide band is accomplished by rotating the retro-reflective mirror.

This invention relates generally to tunable spectral filters using a transmissive diffraction element in double pass configuration and more particularly to a wide-band/high-resolution tunable spectral filter.

### BACKGROUND OF THE INVENTION

Tunable spectral filters have many applications in wavelength multiplexing (WDM) systems, coarse wavelength multiplexing (CWDM) systems, fiber-to-the-home (FTTH) passive optical networks, optical fiber sensing networks such as fiber Bragg grating (FBG) sensor systems, fiber tunable lasers and fiber wavelength-swept lasers, optical component characterizing, laser testing, and amplified spontaneous emission filtering. Traditionally, optical spectral filters have been based on fiber Bragg gratings, thin film dielectric interference filters, Fabry-Perot filters, waveguide micro-resonators, acousto-optic modulators and diffraction gratings. The desirable characteristics associated with a tunable spectral filter include low insertion loss, low PDL, high isolation, flexible accessibility to different resolution configurations, wide tuning range, uniform performance over whole operation range, low cost, high reliability & thermal stability, and compact package.

With reference to FIG. 1, there is a shown prior art of tunable spectral filter using two cascaded transmissive diffraction gratings in U.S. Application No. 2008/0085119 A1. The filter 100 includes an input optical fiber and an output optical fiber, a dual fiber collimator/focuser, two cascaded transmissive diffraction gratings, and a MENS-actuating mirror. The light from the input fiber passes the cascaded gratings experiencing two diffractions and impinges on the mirror. The light disperses in distinct directions corresponding to different spectral components. The mirror reflects only a portion of the input spectral components back through the gratings again to the collimator/focuser. Thus, a preferred spectral component or components of input light can be selected by actuation of the MEMS mirror and coupled into the output. Unfortunately, single diffraction element in this configuration is unable to provide adequate dispersion for 100 GHz spacing spectral (0.8 nm in C-band) even in double pass. As a result, a second diffraction element has to be cascaded into the configuration. Due to the same reason, a third diffraction element has to be added to accumulate sufficient dispersion for 50 GHz spacing (0.4 nm in C-band). Cascading multiple diffraction elements into one filter would increase insertion loss and decrease obtainable tuning range. In addition, the configuration in FIG. 1 lacks flexible accessibility to adjust the spectral resolution of the filter for different application requirements. These disadvantages limit the applications of this embodiment to only 100 GHz and 50 GHz DWDM systems over a single band either C-band or L-band, not for the other purposes mentioned before.

U.S. Pat. No. 7,817,272 B2 proposes a configuration as shown in FIG. 2 by adding an extra rotary reflection mirror and one or more optical elements at front of diffraction element. Essentially it is similar to the prior shown in FIG. 1 except the system consists of a more complex fixture, large body sizes and complicated optical alignments, but still doesn't overcome the disadvantages with the embodiment in FIG. 1.

It is an object of the present invention to provide a tunable spectral filter having increased spectral resolution further over a wide operation band.

It is a further object of the present invention to provide a tunable spectral filter having sufficient flexibility to adjust spectral resolution of a filter.

It is a further object of the present invention to provide a tunable spectral filter with improved insertion loss.

### BRIEF SUMMARY OF THE INVENTION

To overcome the drawbacks of the prior arts, the present invention provides a tunable spectral filter using a single transmissive diffraction element in a double pass configuration, more particularly to implement a wide-band/high-resolution tunable spectral filter with flexible accessibility to adjusting the spectral resolution of the filter for different application requirements. The double pass separated laterally is provided with a retro-reflective mirror. A transmissive diffraction element in low dispersion configuration achieves a wide-band operation. In particular, an anamorphic system is disposed for increasing filter resolution to a desirable level. A half wave plate is disposed between the transmissive diffraction element and the retro-reflective mirror for reducing effectively polarization-dependent loss (PDL).

To achieve a wide operation band, the filter in present invention comprises of a single transmissive diffraction element. Particularly a polarization-independent transmissive grating is preferred. Input light of multiple spectral components is incident on the transmissive diffraction element at a fixed angle, which provides maximum diffraction efficiency. The input light is dispersed towards a retro-reflective mirror after a single pass through the transmissive diffraction element; the plane that the dispersed light occupies is called as diffraction plane (perpendicular to the grooves of diffraction element) herein for convenience. The dispersion produced in a single pass is low compared to that in multiple passes through the same transmissive diffraction element or through multiple diffraction elements like the prior arts. This configuration enables input light of wide spectral components dispersed within a small angle range for the retro-reflective mirror to cover. In other words, a wide band operation can be implemented without actuation of the retro-reflective mirror over a large rotation range.

Unfortunately, this configuration reduces spectral resolution of filter due to the low dispersion configuration. The spectral resolution of a filter is directly related to its transmission bandwidth. High spectral resolution requires filter having a narrow transmission bandwidth. Input light from an input fiber is normally collimated with a lens into a substantially parallel beam with a common propagating axis. However, the fiber core guiding the input light is not a real geometric point, its physical size such as 9 μm of SMF-28 fiber would diverge the collimated light beam somewhat dependent on the parameters and quality of the lens. Thus, the spectral resolution of a fiber pigtail filter is dependent not only on the dispersion of diffraction elements but also on the parameters of input light beam, especially beam divergence. For a given dispersion produced with a diffraction element, a large divergence of input light results in a wide transmission bandwidth, i.e. a low spectral resolution of the filter. Reducing effectively the divergence of input light beam instead of using multiple diffraction elements or multiple passes through the same diffraction element or the combination of both is a unique routine to increases filter spectral resolution in present invention without compromising operation band and insertion loss. Since the dispersion through a diffraction element occurs along one direction perpendicular to the grooves of the diffraction element, controlling the divergence of input light beam along only that direct instead of two transversely orthogonal dimensions is adequate. Therefore, the tunable filter of the present invention utilizes an anamorphic system to control the divergent angle of the input light beam incident on the transmissive diffraction element, ultimately controlling the spectral resolution of the filter. The anamorphic system transforms light beam with different magnifications in perpendicular planes to optical axis; the ratio the magnification in diffraction plane to that in the direction parallel to the grooves of the diffraction element is referred to anamorphic ratio herein for convenience. Varying the anamorphic ratio applied on input light beam can be utilized to adjust the transmission bandwidth of the filter, i.e. the spectral resolution of the filter, to a desirable level. The anamorphic system may consist of either a pair of two lenses with different focal lengths or a pair of prisms. Such the elements with antireflection coating on optical surfaces produce negligible insertion loss.

Advantageously, the retro-reflective mirror used to select the preferred spectral components separates the output path laterally and leave an adequate room to accommodate input/output ports side by side. This eliminates the need for a circulator or coupler to distinguish output from input as certain prior arts, which benefits insertion loss of the filter further over a wide band.

Other features and advantages of the invention will become apparent from the following descriptions and claims.

### BRIEF DESCRIPTION OF THE DRAWINGS

FIG. 1 is a representation of the prior art of using diffraction elements.

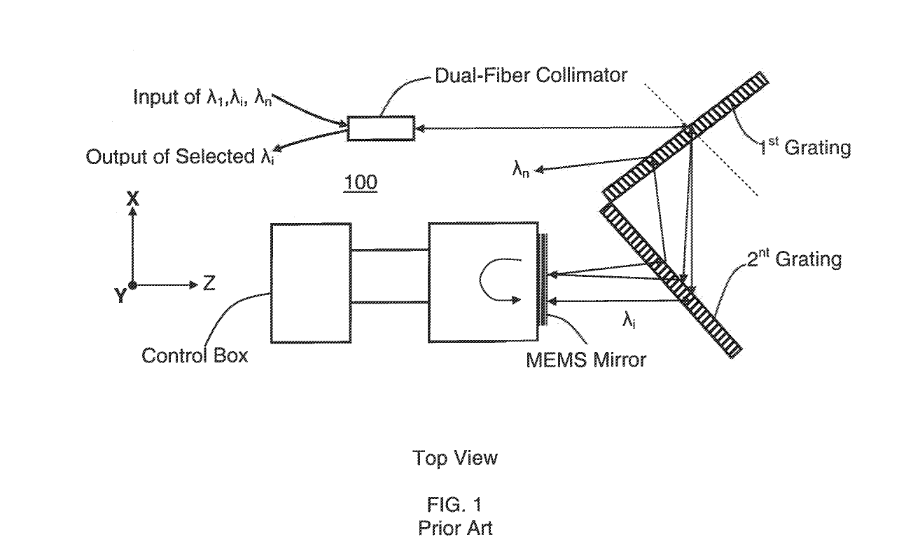

FIG. 2 is a representation of the prior art of using diffraction elements.

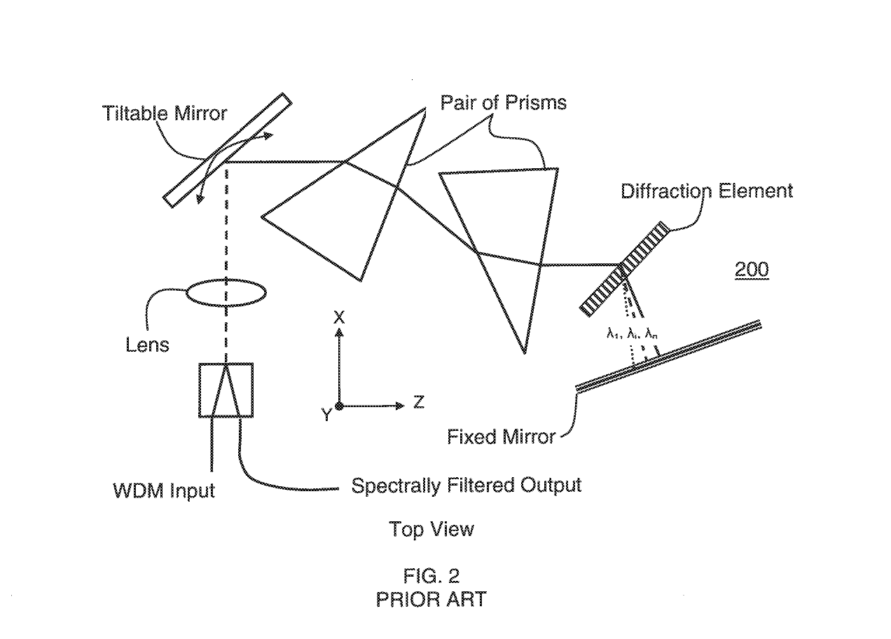

FIG. 3 provides one embodiment of wide-band/high-resolution tunable filter according to the present invention, using an anamorphic system.

FIG. 4 provides one configuration of anamorphic systems according to the present invention.

FIG. 5 provides spectral characteristics of tunable spectral filter with different anamorphic ratios.

FIG. 6 provides a derivative embodiment of FBG interrogation analyzer.

### DETAILED DESCRIPTION OF THE EXEMPLART EMBODIMENTS

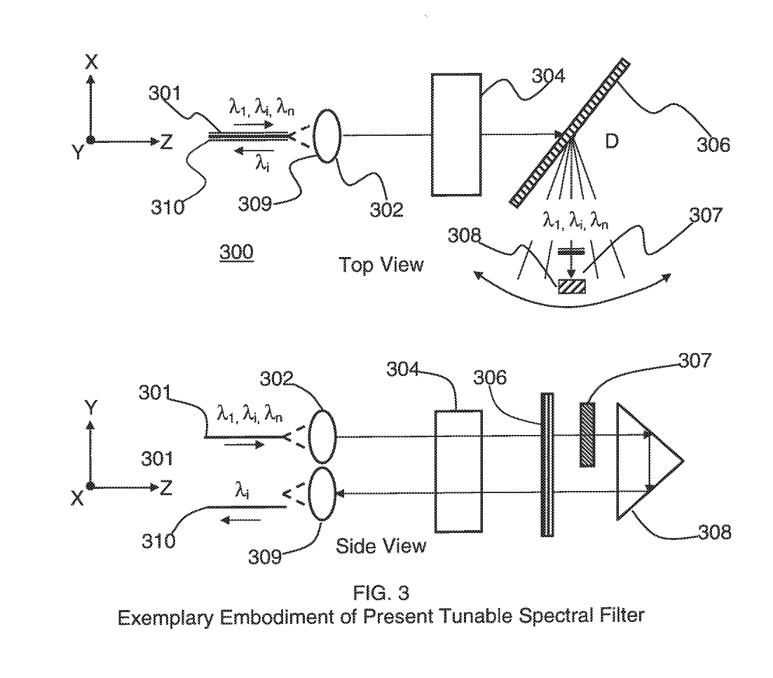

FIG. 3 provides top and side views of one embodiment 300 of the tunable spectral filter, according to the present invention, using one optical transmissive diffraction element. The tunable spectral filter 300 includes input fiber 301, output fiber 310, a collimating lens 302, focusing lens 309, an anamorphic system 304, a transmissive diffraction element 306, a half wave plate 307 and a retro-reflective mirror 308. The retro-reflective mirror is rotary about axis D parallel to y-axis in FIG. 3, which is approximately parallel to the grooves of transmissive diffraction element 306.

In this embodiment, the transmissive diffraction element 306 is preferably a polarization-independent transmissive grating. The collimating lens 302 and focusing lens 309 are conventional gradient index (GRIN) lens or C-lens. The half wave plate 307 is aligned such that its optical axis is inclined at 45° from the diffraction plane to rotate the polarization of the light by 90° after the first pass and before the second pass through the diffraction element. Thus residual polarization-dependent loss (PDL) from the transmissive diffraction element 306 can be reduced significantly in double pass configuration. The retro-reflective mirror 308 is a right angle prism or multiple mirrors or any combinations of optical elements.

With reference to FIG. 3, input light consisting of multiple spectral components or wavelengths (λ₁, λᵢ, λₙ) is a substantially parallel beam collimated by the lens 302. The collimated beam is expended transversely by the anamorphic system 304 in only one direction within the diffraction plane of the transmissive diffractive element 306 (along x-axis in FIG. 3) and is subsequently incident on the transmissive diffraction element 306. Transversely expanding input light beam in turn reduces the divergent angle of the beam in that direction. The transmissive diffractive element 306 disperses the constituent spectral components of the input beam angularly such that different spectral components propagate along distinct propagation axes within the diffraction plane (x-z plane in FIG. 3). The half wave plate 307 is configured to rotate the polarization of input light by an angled of 90°. Retro-reflective mirror 308 receives, displaces, and reflects one or more spectral components in the first pass after the transmissive diffraction element 306 back towards the transmissive diffraction element 306. Consequently, the reflected light experiences the dispersion again through the transmissive diffraction element 306 in the second pass and is dispersed further. The light that is not captured by retro-reflective mirror would pass by the transmissive diffraction mirror and is absorbed inside the filter housing. It is understood that the selection on spectral components herein is configured to receive light from the first dispersion of transmissive diffraction element 306. The reflected spectral components are incident on the transmissive diffraction element 306 a second time and dispersed further. This double pass configuration through the same grating benefits the spectral resolution of the filter. The retro-reflective mirror 308 is rotary about axis D parallel to the grooves of the transmissive diffraction element 306 (y-axis in FIG. 3). The retro-reflective mirror is to select one spectral component or small portion of all spectral components. Rotating to different locations allows the retro-reflective mirror to select different spectral components backwards to transmissive diffraction element 306, which may be coupled into output fiber 310 by the focusing lens 309.

Dispersion angle of a transmissive diffraction grating is governed by the following equation:

mλ= [symbol] (sin θᵢ+sin θ_{d})

Where m is the m^{th} diffraction order, λ is the wavelength (spectral component) of the illumination, [symbol] is the grating period, θᵢ and θ_{d} are incident and diffraction angles of illumination respectively for the m^{th} diffraction order. The dispersion of single diffraction with the filter is dθ/dλ=m/ [symbol] cos θ_{d}. In the present invention, the transmissive diffraction grating in low dispersions configuration is 1-order diffraction (m=1) for achieving maximum efficiency. For λ=1545 nm, and [symbol] =940 lines/mm, the incident angled under Bragg condition is 46.56°, then the dispersion is 0.078°/nm in single pass and 0.156°/nm in double pass through the diffraction grating. Such a low dispersion of 0.078°/nm in single pass benefits a wide operation band of the filter but enables the filter having a low spectral resolution.

As mentioned above the spectral resolution or transmission bandwidth of a fiber pigtail filter is dependent on not only the dispersion of diffraction element but also the divergence of input/output light beams. A large divergence of input light beam requires a large dispersion from the diffraction element for distinguishing adjacent spectral components with a given interval. Anamorphic system 304 is used in present invention to reduce significantly the divergence of the input light beam within the diffraction element. Since the dispersion of a diffraction element occurs only within the diffraction place, the beam or beam divergence transformation is only needed in one dimension.

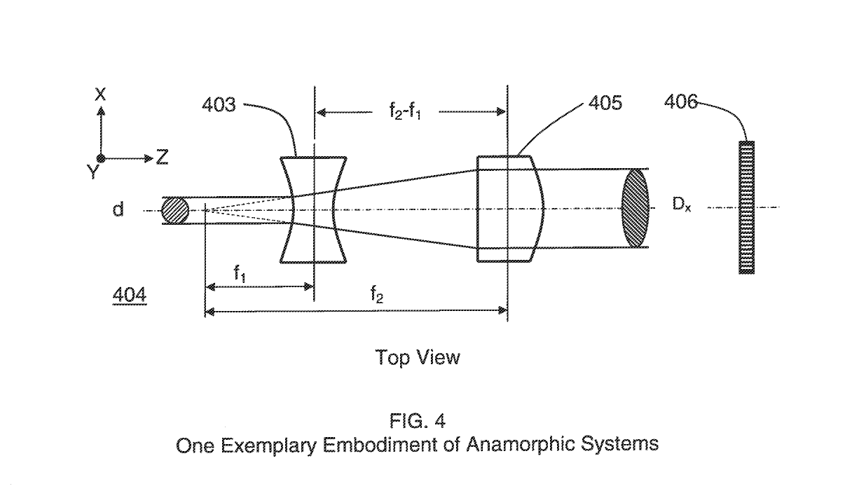

One exemplary embodiment 404 of anamorphic systems is shown in FIG. 4. It consists of a negative (diverging or divergent) cylindrical lens 404 either plano-concave or double-concave cylindrical lens with a focal length of f₁ and a positive (converging or convergent) cylindrical lens 406 either plano-convex or double-convex cylindrical lens with a focal length of f₂. The two cylindrical lenses 404, 406 are configured to substantially preserve collimation of the input light beam by expanding beam size in the diffraction plane (x-z plane in FIG. 4) while keeping the beam size substantially the same in the direction (y-axis in FIG. 4) perpendicular to the diffraction plane. The beam size within the diffraction plane is magnified by an anamorphic ratio of f₂/f₁, assuming f₂>f₁ but not limited to, i.e. d/Dₓ=f₂/f₁ where d and Dₓ indicate the beam sizes within the diffraction plane (x-z plane in FIG. 4) before and after passing through the anamorphic system 404 respectively. The divergent angle of the input light beam after passing the anamorphic system 404 is reduced by the same anamorphic ratio of f₂/f₁ while the divergence of the light beam in y-axis in FIG. 4 is substantially the same. A smaller divergent angle of input light beam needs a lower dispersion from the diffraction element for identifying adjacent spectral components with a given interval (i.e. higher spectral resolution of the filter). Thus the anamorphic system 404 can improve significantly the spectral resolution of the filter by controlling divergent angle of input light beam within diffraction plane. The exemplary combination of a negative cylindrical and a positive cylindrical lens in FIG. 4 also reduces effectively optical aberration, assuming that their individual aberrations against each other. But this is not a limitation to use two positive cylindrical lenses to build a similar anamorphic system for the same purposes above.

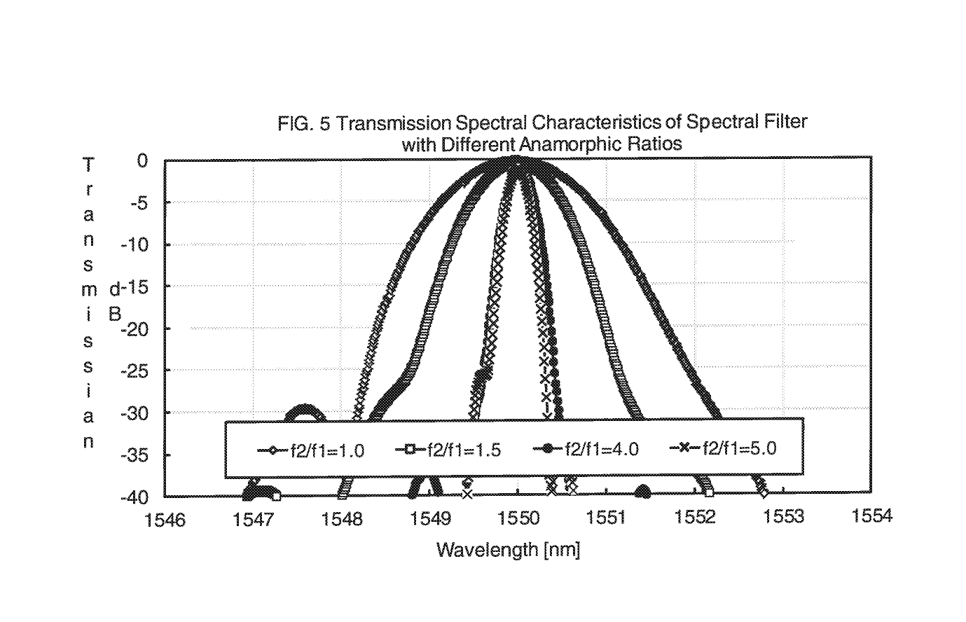

The existence of the anamorphic system in the present invention provides a flexible solution to adjust the spectral resolution of the filter to a desirable number by varying anamorphic ratios of f₂/f₁ without increasing extra insertion loss. FIG. 5 shows the transmission spectral characteristics of the invented tunable filter with different anamorphic ratios of f₂/f₁. Thus the spectral resolution of the filter is dependent significantly on the anamorphic ratios of f₂/f₁. The spectral resolution of the filer can be adjusted flexible by varying the anamorphic ratio of f₂/f₁.

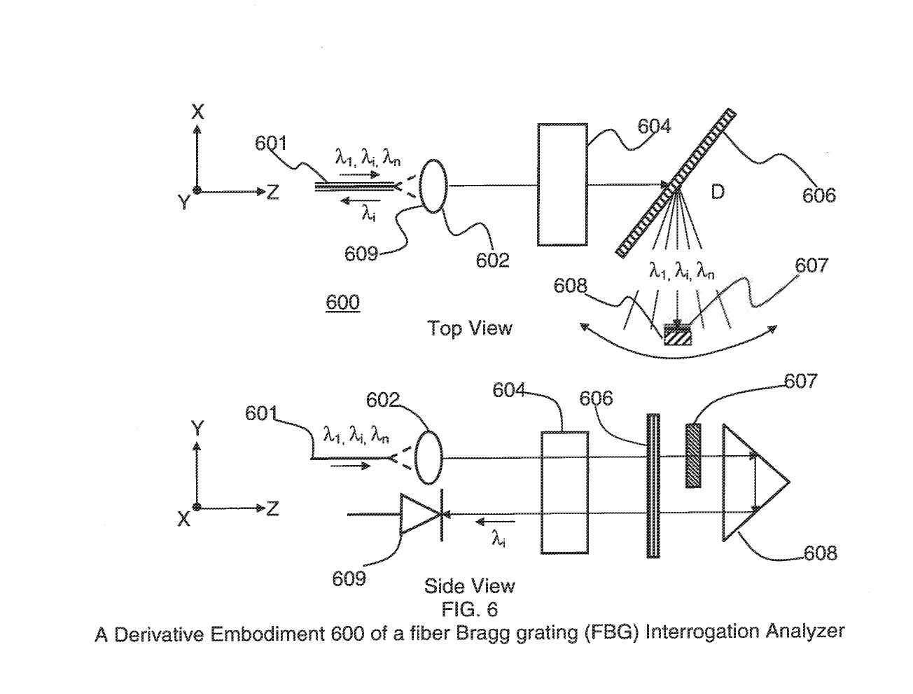

FIG. 6 shows a top and side views of a derivative embodiment 600 of a fiber Bragg grating (FBG) interrogation analyzer, according to the present invention, intended for applications as optical channel monitors or fiber Bragg grating (FBG) interrogation analyzers. This embodiment is similar to that in FIG. 3 but a photo-detector or photodiode 609 is implemented onto the output side. In FIG. 6, optical elements 601, 602, 604, 606, 607, 608 serve substantially the same functions as those of the elements 301, 302, 304, 306, 307, 308 in FIG. 3 respectively. The operation of the embodiment 600 shown in FIG. 6 is similar to the operation of the embodiment 300 shown in FIG. 3 as the prior description, except of focusing selected backward spectral components into output fiber 310, such the spectral component is captured by the photo-detector 609.

Numerous other embodiments may be envisaged, without departing from the spirit and scope of the invention.

What is claimed is:

1. A tunable spectral filter device, comprising:
An anamorphic system disposed for transforming the divergence of input light beam within diffraction plane to a desirable level, while keeping the divergence of the input light beam substantially the same in the direction perpendicular to the diffraction plane;
A single spectrally transmissive diffraction element is configured to receive the input light exiting the anamorphic system at a fixed incident angle and a fixed location, and configured to disperse spectral components of the input light beam at different respective angels within the diffraction plane;
A half wave plate disposed for rotating the polarization of the dispersed spectral components by 90° after the first pass through the transmissive diffraction element;
A retro-reflective mirror disposed for reflecting the dispersed spectral components to the transmissive diffraction element by displacing beam path a separation laterally away from input light along the grooves of the transmissive diffraction element.

2. The device of claim 1, wherein the optic axis of the half waveplate is aligned by 45° relative to the grooves of the transmissive diffraction element.

3. The device of claim 1, wherein the retro-reflective mirror is rotary about an axis perpendicular to the diffraction plane and selects a portion of the dispersed spectral components.

4. The Device of claim 3, wherein the retro-reflective mirror is configured to direct the selected spectral components to be dispersed a second time by the transmissive diffraction element.

5. The device of claim 1, wherein the anamorphic system is configured to substantially preserve collimation of the input light beam when transforming beam sizes.

6. The device of claim 5, wherein the anamorphic system is configured to transform the divergence angled of the input light beam only within the diffraction plane while keeping the divergence angle of the input light beam substantially the same in the direction perpendicular to the diffraction plane.

7. The device of claim 5, wherein the anamorphic system comprises a pair of cylindrical lenses having different focal lengths.

8. The device of claim 6, wherein the pair of cylindrical lenses comprises a negative cylindrical lens and a positive cylindrical lens, wherein the two cylindrical lenses are separated by a distance that is approximately the difference of their focal lengths.

9. The device of claim 1, wherein the retro-reflective mirror comprises a right angle prism having anti-reflection coating on hypotenuse surface.

10. The device of claim 1, wherein the retro-reflective mirror comprises two or more than two mirrors.

11. A fiber Bragg grating (FBG) interrogation analyzer, comprising:
An anamorphic system disposed to transform the divergence of input light beam in diffraction place to a desirable level, while keeping the divergence of the input light beam substantially the same in the direction perpendicular to the diffraction plane;
A spectrally transmissive diffraction element configured to receive the input light exit beam from the anamorphic system at a fixed incident angle and a fixed location, and configured to disperse spectral components of the input light beam at different respective angels in a diffraction plane;
A half wave plate disposed for rotating the polarization of the dispersed spectral components by 90° after the diffraction element;
A retro-reflective mirror disposed for reflecting the dispersed spectral components to the transmissive diffraction element by displacing beam path a separation laterally away from input light along the grooves of the transmissive diffractive element.
A photo-detector disposed for receiving the spectral components of input light selected by the retro-reflective mirror.
